(19) United States
(12) Patent Application Publication
(10) Pub. No.: US 2026/0043282 A1
(43) Pub. Date: Feb. 12, 2026

(54) LATCH

(71) Applicant: Hampton Products International Corporation, Foothill Ranch, CA (US)

(72) Inventors: Chia-Hung LIN, Taichung (TW); Mark EMORY, Fullerton, CA (US)

(73) Assignee: Hampton Products International Corporation, Foothill Ranch, CA (US)

(21) Appl. No.: 19/321,695

(22) Filed: Sep. 8, 2025

Related U.S. Application Data
(60) Provisional application No. 63/680,472, filed on Aug. 7, 2024.

(51) Int. Cl. E05C 1/16; E05B 15/00; E05B 15/04

(52) U.S. Cl. CPC E05C 1/16; E05B 15/0033; E05B 15/04; E05B 2015/0496

(57) ABSTRACT

A latch assembly comprises a housing, a latch movable at least partially within the housing from a retracted position to an extended position, and a cam rotatably secured to a cavity inside the housing. The latch comprises a cutout having two cam surfaces diverging from a back end to two front ends of the cam surfaces. The cam comprises a nose engaged with at least one cam surface at the back end when the latch is in the extended position, and engaged with one of the cam surfaces towards the front end of one of the cam surfaces.

### FIELD

The subject matter herein generally relates to door locks and specifically, a latch assembly for a door lock.

### BACKGROUND

A typical door lock includes an outside handle assembly, an inside handle assembly, and a latch assembly. The outside handle assembly is generally mounted to an exterior side of a door, the inside handle assembly is generally mounted to an interior side of the door, and the latch assembly is generally mounted inside the door between the outside and the inside handle assemblies.

### BRIEF DESCRIPTION OF THE DRAWINGS

Implementations of the present technology will now be described, by way of example only, with reference to the attached figures, wherein:

FIG. 1 is an isometric view of a door lock assembly, the lock assembly comprising an outside handle assembly, an inside handle assembly, and an embodiment of a latch assembly.

FIG. 2 is a partially exploded view of the latch assembly in FIG. 1 with a housing cover and a faceplate detached from a housing.

FIG. 3 is an exploded view of the latch assembly of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

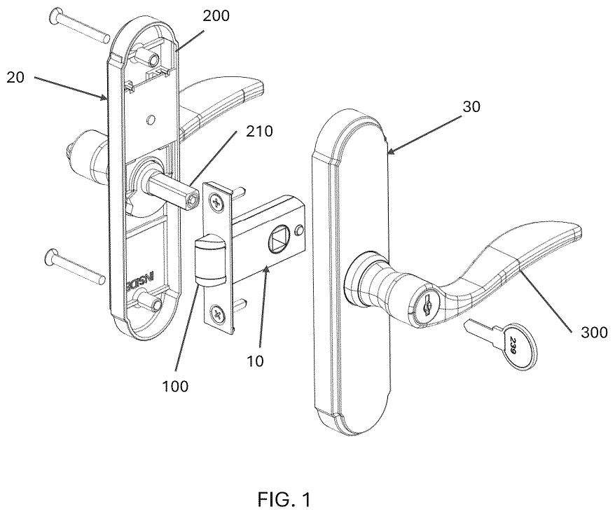

FIG. 1 illustrates a door lock assembly comprising an embodiment of a latch assembly 10, an inside handle assembly 20, and an outside handle assembly 30. The inside handle assembly 20 comprises an inside handle 200 and a spindle 210 coupled to the inside handle 200. When the lock assembly is installed on a door, the spindle 210 passes through the latch assembly 10 and couples to the outside handle 300 of the outside handle assembly 30. This enables the latch 100 of the latch assembly 10 to retract into a housing of the latch assembly 10 from an extended position to a retracted position when either the inside handle 200 or outside handle 300 is turned in either a clockwise or counterclockwise direction, as elaborated upon below.

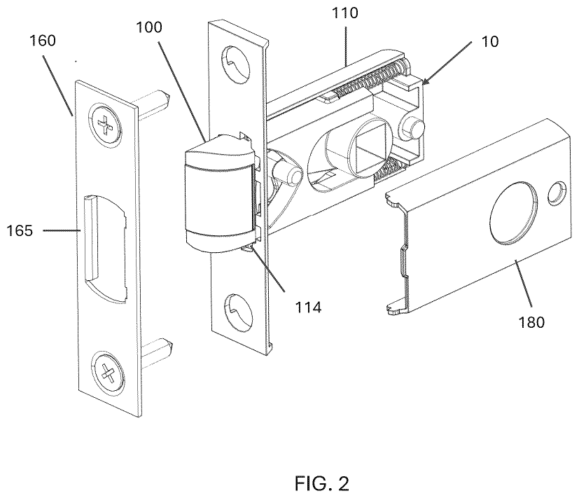

Referring to FIG. 2, the latch assembly 10 includes a housing 110, a faceplate 160 and a housing cover 180 that are removably coupled to the housing 110, and a latch 100 that can move along a latch axis between the extended position with a portion of the latch 100 extending out a latch opening 114 of the housing 110 (and a faceplate opening 165 of the faceplate 160), and a retracted position with the latch 100 retracted at least partially within the housing 110. One or more elastic elements 120 such as springs can be added to urge the latch 100 in a normally extended position. This is additionally helpful when the handles 100, 200 do not have springs to return the latch in a normally extended position.

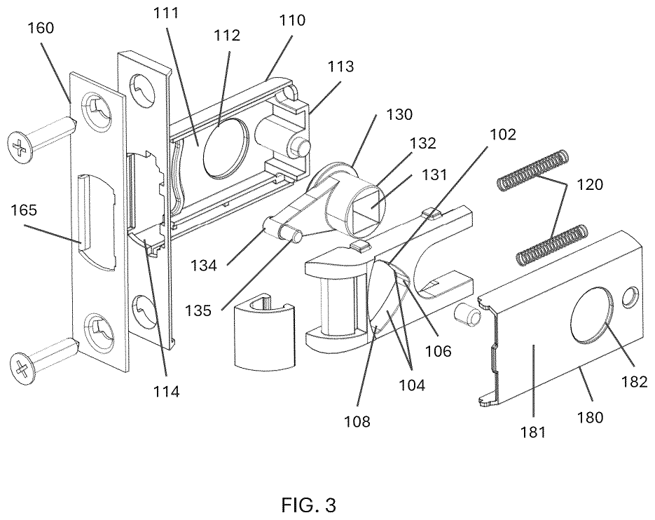

The housing 110 includes a cavity 115 formed by a boundary wall 111 and a plurality of sidewalls 113 extending from the boundary wall 111. As illustrated in the embodiment of FIG. 3, four sidewalls 113 extend perpendicularly from the boundary wall 111 to cooperatively form a rectangular cavity 115. The boundary wall 111 has a cam opening 112 defined therein, and one of the sidewalls 113 has a latch opening 114 through which the latch 110 can move. The housing cover 180 also has a boundary wall 181 and a cam opening 182. The cam openings 112, 182 at opposite boundary walls 111, 181 of the housing 110 and the housing cover 180 can be circular to partially capture a cam 130 inside the cavity 115 between the boundary walls 111, 181 and permit the cam 130 to rotate about the cam openings 112, 182, as discussed in further detail below.

In the illustrated embodiment, the cam 130 is egg shaped (e.g., eccentric cam), but the cam 130 can have any shape. The cam 130 includes a base 132 and a nose 134 extending from the base 132. The base 132 defines a spindle opening 131 slightly larger than the spindle 201 and similarly shaped so that the spindle 210 can extend through the base 132 and control rotation of the cam 130 by rotation of the inside handle 200 of the inside handle assembly 20 or the outside handle 300 of the outside handle assembly 30 about a rotation axis (illustrated in FIG. 1). That is, the handles 200, 300, spindle 210, and cam 130 rotate about the same rotation axis. As shown, the base 132 is cylindrical and extends outwardly beyond at least a portion of sides of the nose 134 to capture and secure the cam 130 within the housing 110 and the housing cover 180 and at least partially into the cam openings 112, 182 at the opposite boundary walls 111, 181 of the housing 110 and the housing cover 180. The nose 134 can further include a protrusion 135, such as a post, and even further, a roller sleeve 136 rotatable sleeved on the protrusion 135, in contact with the latch 100. The roller sleeve 136 could be a hollow cylindrical component sleeved around the protrusion 135, restrained in an axial direction and rotatable about the protrusion 135. In this embodiment, the roller sleeve has an inside diameter slightly larger than a diameter of the protrusion 135 that can include a lubricant therebetween to reduce friction between the roller sleeve and the post. In operation, rotation of the cam 130 about the rotation axis retracts the latch 100 linearly into the housing 110.

The primary function of the latch 100 is to maintain the door in a closed position. Specifically, when the door is in a closed position, the latch 100 is in an extended position and engages a strike plate (not shown) to prevent the door from opening. To release the door from the closed position, one of the handles 200, 300, can be rotated to rotate the spindle 210, thereby rotating the cam 130 and retracting the latch 100 at least partially into the housing 110 and completely out of the strike plate. The latch 100 includes a cutout 102 that allows the cam 130 to press against one of at least two cam surfaces 104 of the cutout 100 to retract the latch 100 and against the elastic element 120. The cam surfaces diverge outwardly from a back end 106 of the cam surfaces 104 to front ends 108 of the cam surfaces 104. In the normally extended position, the nose 134 or protrusion 135 sits in the back end 106. When the cam 130 is rotated in a particular direction, the nose 134 (or the protrusion 135) presses against one of the cam surfaces 104 and based on the diverging geometry of the cam surface 104, forces the latch 100 to retract as the nose 134 (or protrusion) moves towards one of the front ends of 108. Similarly, when the cam 130 is rotated in the opposite direction, the nose 134 (or the protrusion 135) presses against the other cam surface 104 and forces the latch to retract as the nose 134 (or protrusion) moves towards the other front end of 108 of the cam surface 104. The cam surfaces 104 can have a flat planar shape or form a curvature to control retraction

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A latch assembly comprising a housing, a latch movable at least partially within the housing from an extended position to a retracted position, and a cam rotatably secured to a cavity inside the housing, the latch comprising a cutout having two cam surfaces diverging between a back end to a front end of the cam surfaces, the cam comprising a nose engaged with at least one cam surface at the back end when the latch is in the extended position, and engaged with one of the cam surfaces towards the front end of one of the cam surfaces in the retracted position.

2. The latch assembly of claim 1, wherein the nose of the cam comprises a protrusion engaging the at least one cam surfaces.

3. The latch assembly of claim 2, wherein the cam further comprises a roller sleeved around the protrusion to reduce friction between the cam and the latch.

4. The latch assembly of claim 3, wherein the cam is an eccentric cam.

5. The latch assembly of claim 1, further comprising one or more springs to urge the latch towards the extended position.

6. A door lock assembly comprising an inside handle assembly, an outside handle assembly, and the latch assembly of claim 1.

7. The door lock assembly of claim 6, further comprising a spindle coupled to the cam between an inside handle of the inside handle assembly and an outside handle of the outside handle assembly.

8. A latch assembly comprising a housing, a latch comprising a cam surface extending between a first end of the latch and a second end of the latch, and a cam, wherein a portion of the cam slides along the cam surface of the latch to retract the latch at least partially inside the housing between an extended position and a retracted position.

9. The latch assembly of claim 8, wherein the latch comprises two cam surfaces.

10. The latch assembly of claim 9, wherein the cam surfaces diverge between the first end of the latch to the second end of the latch.

11. The latch assembly of claim 8, wherein the portion of the cam comprises a protrusion extending away from a surface of the cam.

12. The latch assembly of claim 8, wherein the portion of the cam comprises a roller in contact with the cam surfaces.
